(19) United States
(12) Patent Application Publication
(10) Pub. No.: US 2024/0162453 A1
(43) Pub. Date: May 16, 2024

(54) PREPARATION METHOD FOR AND USE OF SELF-ASSEMBLY-BASED NITROGEN-DOPED ORDERED POROUS PRECIOUS METAL NANOMATERIAL

(71) Applicant: GUANGZHOU INSTITUTE OF ENERGY CONVERSION, CHINESE ACADEMY OF SCIENCES, Guangzhou (CN)

(72) Inventors: Zhida WANG, Guangzhou (CN); Changfeng YAN, Guangzhou (CN); Yi YANG, Guangzhou (CN); Zhuoxin LU, Guangzhou (CN); Yan SHI, Guangzhou (CN); Changqing GUO, Guangzhou (CN); Hongyi TAN, Guangzhou (CN); Lisha SHEN, Guangzhou (CN); Linxiu DENG, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 18/279,880

(22) PCT Filed: Mar. 19, 2021
(86) PCT No.: PCT/CN2021/081666

§ 371 Date: Sep. 1, 2023

(30) Foreign Application Priority Data
Mar. 1, 2021 (CN) 202110226438.1

(51) Int. Cl. H01M 4/92; H01M 4/86; H01M 4/88

(52) U.S. Cl. CPC H01M 4/926; H01M 4/8605; H01M 4/8875; H01M 2004/8689

(57) ABSTRACT

Provided are a preparation method for and use of a self-assembly-based nitrogen-doped ordered porous precious metal nanomaterial. The preparation method includes: with a pyridine nitrogen-containing amphiphilic block copolymer as a structure-directing agent and a phenolic resin as a template agent, adding a precious metal precursor, inducing self-assembly by means of volatilization of a solvent, and carbonizing in an inert atmosphere to prepare the nitrogen-doped ordered porous precious metal nanomaterial. The regularity, dispersity and uniformity of the precious metal nanomaterial are achieved; the problems of migration and inactivation after agglomeration of precious metal nanoparticles are solved; the lifespan of precious metal particles is prolonged; and in addition, the ORR electro-catalytic property of the material can be improved, and the nitrogen-doped ordered porous precious metal nanomaterial can be used to prepare a cathodic oxygen reduction catalyst for a fuel cell.

### CROSS REFERENCE TO THE RELATED APPLICATIONS

This application is the national phase entry of International Application No. PCT/CN2021/081666, filed on Mar. 19, 2021, which is based upon and claims priority to Chinese Patent Application No. 202110226438.1, filed on Mar. 1, 2021, the entire contents of which are incorporated herein by reference.

### TECHNICAL FIELD

The present invention relates to the field of nanomaterials and electrochemistry, and more particularly, to a preparation method for and use of a self-assembly-based nitrogen-doped ordered porous precious metal nanomaterial.

### BACKGROUND

Structure-controllable precious metal nanomaterials have extremely high application values in medicine, biochemical sensing or the like, and also show a broad application prospect in fields such as catalytic conversion, optoelectronic materials and energy storage. In the field of fuel cells, precious metal platinum (Pt) is often used as a catalytic material for the cathodic oxygen reduction reaction (ORR) due to its excellent stability and catalytic activity, and carbon-carried platinum (Pt/C) catalysts are commonly used at present. The structural design and optimization of Pt/C catalytic materials is a core task in the development of catalysts for fuel cells, so it is necessary to develop a novel catalytic material with long lifespan and low Pt loading capacity to achieve the purpose of improving the performances of membrane fuel cells.

The doping of nitrogen atoms in a catalyst carbon carrier material is crucial for the modification of Pt/C catalysts. The nitrogen atom has a radius similar to that of a carbon atom, and five extra-layer valence electrons of the nitrogen atom are prone to the formation of covalent bonds with carbon atoms to replace carbon atoms at different positions in a carbon lattice, thereby forming different types of nitrogen-doped structures, such as pyridine nitrogen, pyrrole nitrogen, graphite nitrogen or the like, which leads to the formation of defects and the increase in oxygen adsorption sites. In addition, the nitrogen atom has high electronegativity, which can change the charge distribution of carbon atoms to thus change the oxygen adsorption, thereby adjusting the chemical activity of a catalyst and improving the performances of ORR.

Porous nanomaterials have pores in a three-dimensional mesh-like porous structure, showing unique properties such as ultra-high specific surface area and high durability. The porous structure provides excellent mass transfer channels for oxygen reduction; and the large number of margin and defect sites provide more active centers for oxygen reduction. At present, porous precious metal nanomaterials are usually prepared with a co-precipitation or impregnation method. For the co-precipitation method, it is difficult to control the structures and sizes of pore channels, and also difficult to remove surface ligands from precious metal nanoparticles. In the impregnation method, it is difficult for a precious metal precursor to enter the pore channels of the porous structure, resulting in a low internal utilization rate of the material and an uneven loading capacity.

### SUMMARY

An object of the present invention is to provide a preparation method for and use of a self-assembly-based nitrogen-doped ordered porous precious metal nanomaterial, in which, with a pyridine nitrogen-containing amphiphilic block copolymer as a structure-directing agent and a phenolic resin as a template agent, a precious metal precursor is added, and self-assembly and carbonization are induced by means of volatilization of a solvent to prepare the nitrogen-doped ordered porous precious metal nanomaterial. The present invention achieves the regularity, dispersity and uniformity of the precious metal nanomaterial with simple operation. By means of self-assembly and in-situ pyridine nitrogen anchoring of precious metal particles, the precious metal is anchored to the surface or wall of the porous structure through the electronic effect, which achieves the uniform loading of active sites for precious metal nanoparticles, solves the problem of easy migration and inactivation after agglomeration of the precious metal nanoparticles, prolongs the lifespan of precious metal particles, and meanwhile also changes the charge distribution of carbon atoms to accelerate the breakage of O—O bonds and improve the ORR electrocatalytic performance of the material. The present invention has a broad application prospect. In addition, the porous material has a high specific surface area, which contributes to the transport and diffusion of reactants inside the material, such that the catalytic performance of the material can be improved. The method of the present invention is applicable to the preparation of a ORR catalyst for fuel cells.

The object of the present invention is achieved by the following technical solution.

A preparation method for a self-assembly-based nitrogen-doped ordered porous precious metal nanomaterial includes: with a pyridine nitrogen-containing amphiphilic block copolymer as a structure-directing agent and a phenolic resin as a template agent, adding a precious metal precursor, inducing self-assembly by means of volatilization of a solvent, and carbonizing in an inert atmosphere to prepare the nitrogen-doped ordered porous precious metal nanomaterial, wherein the nitrogen-doped ordered porous precious metal nanomaterial has a honeycomb- or mesh-like porous structure with pore channels orderly arranged and precious metal particles uniformly located on surfaces or walls of the porous nanomaterial. The following specific steps are included:
(1) dissolving the amphiphilic block copolymer and the phenolic resin at a weight ratio of 1:(0.5-3) in N,N-dimethylformamide, and stirring to form a clear organic solution, the amphiphilic block copolymer having a concentration of 3-10 mg/mL;
(2) adding the precious metal precursor to the solution obtained in step (1), and continuing to stir to form an organic/precious metal precursor solution, a molar ratio of a precious metal in the precious metal precursor to a hydrophilic block unit in the amphiphilic block copolymer being 1:(1-50);
(3) transferring the solution obtained in step (2) to a carrier, and performing self-assembly at room temperature to form an organic/precious metal template; and
(4) carbonizing the organic/precious metal template obtained in step (3) at a temperature between 400° C. and 500° C. in an inert atmosphere, and then performing reduction by introducing a reducing gas at the same temperature to obtain the nitrogen-doped ordered porous precious metal nanomaterial.

In the amphiphilic block copolymer, a hydrophilic block is a pyridine-containing block capable of interacting with the precious metal precursor by hydrogen bonding, and is preferably selected from poly-(4-vinylpyridine) or poly-(2-vinylpyridine); and a hydrophobic block is a polymer with a hydrophobic property, and is selected from, for example, polystyrene.

The precious metal in the precious metal precursor includes, but is not limited to, one or more of platinum, gold, iridium, and ruthenium.

The orderly arranged pores of the nitrogen-doped ordered porous precious metal nanomaterial each have a diameter in a range of 10 nm to 200 nm; and the precious metal particles have diameters in a range of 0.2 nm to 25 nm.

The carrier in step (3) includes any one of carbon paper, ITO glass, or a silicon wafer.

The present invention further claims use of the nitrogen-doped ordered porous precious metal nanomaterial for catalysis on a cathode of a fuel cell. The nitrogen-doped ordered porous precious metal nanomaterial is for use in preparation of a cathodic oxygen reduction catalyst for the fuel cell. A method is as follows:

for a half cell: dropping 5 μl of 0.05% perfluorosulfonic acid-polytetrafluoroethylene Copolymer™ (Nafion™) onto a rotating disc glassy carbon electrode, and 3 minutes after solvent volatilization, contacting the rotating disc electrode (RDE) with a carrier loading the nitrogen-doped ordered porous precious metal nanomaterial for 24 hours, to transfer a porous structure to a platinum-carbon electrode; and

for a single cell: spin-coating the organic/precious metal precursor solution from step (2) to a piece of carbon paper of 2×2 cm², performing the remaining steps that are the same as those for the half cell, to obtain a carbon paper-loaded nitrogen-doped ordered porous noble metal nanomaterial, and then assembling a membrane electrode (MEA) for a fuel cell test.

The present invention has the following beneficial effects:
1) the self-assembly and in-situ doping of pyridine nitrogen in the present invention can change the charge distribution of carbon atoms to contribute to the adsorption of oxygen molecules and the accelerated breakage of 0-0 bonds, and also lead to the formation of more defects, whereby more oxygen adsorption active sites are formed to improve the ORR electrocatalytic performance of the material;
2) precious metal atoms are anchored with doped nitrogen in the present invention, such that the precious metal atoms are fixed on the surface or wall of the pore channel to achieve uniform distribution of the precious metal active sites, which solves the problem of the migration and agglomeration of metal nanoparticles and improves the utilization and the stability of the precious metal;
3) the structure of the porous precious metal material prepared by the present invention tends to exhibit single distribution in terms of size, spacing and shape, such that the dispersity, regularity and uniformity desired by the preparation of precious metal nanomaterials are achieved; and
4) the present invention can be constructed on different substrates (such as carbon paper, ITO glass, or silicon wafers) to adapt to different applications such as optoelectronic materials, sensing materials or other application requirements.

In summary, the present invention achieves the regularity, dispersity and uniformity of the precious metal nanomaterial with simple operation. By means of self-assembly and in-situ pyridine nitrogen anchoring of precious metal particles, the precious metal is anchored to the surfaces or walls of the porous structure by means of electronic effects, which achieves the uniform loading of active sites for precious metal nanoparticles, solves the problem of migration and inactivation after agglomeration of the precious metal nanoparticles, prolongs the lifespan of the precious metal particles, and can also change the charge distribution of carbon atoms to accelerate the breakage of O—O bonds and improve the ORR electrocatalytic performance of the material. The present invention has a broad application prospect. In addition, the porous material has a high specific surface area, which contributes to the transport and diffusion of reactants in the material, such that the catalytic performance of the material can be improved. The present invention is applicable to the preparation of a cathodic oxygen reduction catalyst for fuel cells.

### BRIEF DESCRIPTION OF THE DRAWINGS

FIG. 1A shows an SEM picture of a nitrogen-doped ordered porous precious metal nanomaterial according to Embodiment 1, FIG. 1B shows a brightfield TEM photo, FIG. 1C shows EDS elemental analysis, and FIG. 1D shows an XPS map;

FIG. 2A shows LSV curves of the nitrogen-doped ordered porous precious metal nanomaterial according to Embodiment 1, and FIG. 2B shows K-L curves of the nitrogen-doped ordered porous precious metal nanomaterial according to Embodiment 1, under 0.4 V, 0.5 V, 0.6 V, and 0.7V;

FIG. 3 shows CV curves of a nitrogen-doped ordered porous Pt nanomaterial according to Embodiment 2;

FIG. 4 shows I-V polarization curves of a nitrogen-doped ordered porous Pt nanomaterial according to Embodiment 3;

FIG. 5 shows an SEM picture of a nitrogen-doped ordered porous Pt nanomaterial according to Embodiment 4;

FIG. 6 shows an SEM image of a nitrogen-doped ordered porous Pt nanomaterial according to Embodiment 5;

FIG. 7A shows a darkfield TEM photo of a nitrogen-doped ordered porous Pt nanomaterial prepared in Embodiment 6, and FIG. 7B shows a darkfield TEM photo of the distribution of the Pt single atoms;

FIG. 8 shows an SEM picture of a nitrogen-doped ordered porous Pt nanomaterial according to Embodiment 7;

FIGS. 9A and 9B show an SEM picture of a nitrogen-doped ordered porous Pt nanomaterial according to Embodiment 8, where FIG. 9A shows a porous structure diagram at a withdrawal rate of 3 mm/min, and FIG. 9B shows a porous structure diagram at a withdrawal rate of 1 mm/min;

FIGS. 10A and 10B show an SEM picture of a nitrogen-doped ordered porous Pt nanomaterial according to Embodiment 9, where FIG. 10A shows a porous structure diagram at a spin-coating rate of 400 rpm, and FIG. 10B shows a porous structure diagram at a spin-coating rate of 3,000 rpm;

FIGS. 11A and 11B show an SEM picture of a nitrogen-doped ordered porous Au nanomaterial obtained in Embodiment 10, where FIG. 11A shows a porous structure diagram at a withdrawal rate of 3 mm/min, and FIG. 10B shows a porous structure diagram at a withdrawal rate of 5 mm/min;

FIGS. 12A and 12B shows an SEM picture of a nitrogen-doped ordered porous Ir nanomaterial obtained in Embodiment 11, wherein FIG. 12A shows a porous structure diagram at a withdrawal rate of 3 mm/min, and FIG. 12B shows a porous structure diagram at a withdrawal rate of 5 mm/min;

FIG. 13 shows an SEM picture of a nitrogen-doped ordered porous Ru nanomaterial obtained in Embodiment 12; and

FIG. 14 shows an SEM picture of a nitrogen-doped ordered porous PtRu nanomaterial obtained in Embodiment 13.

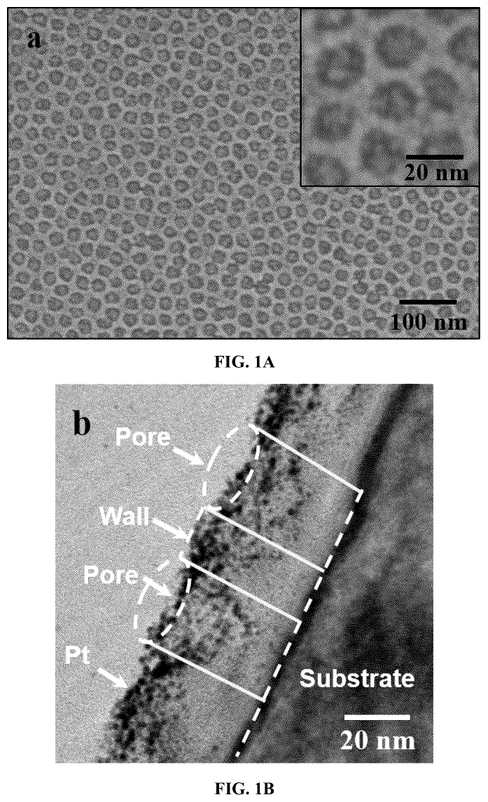

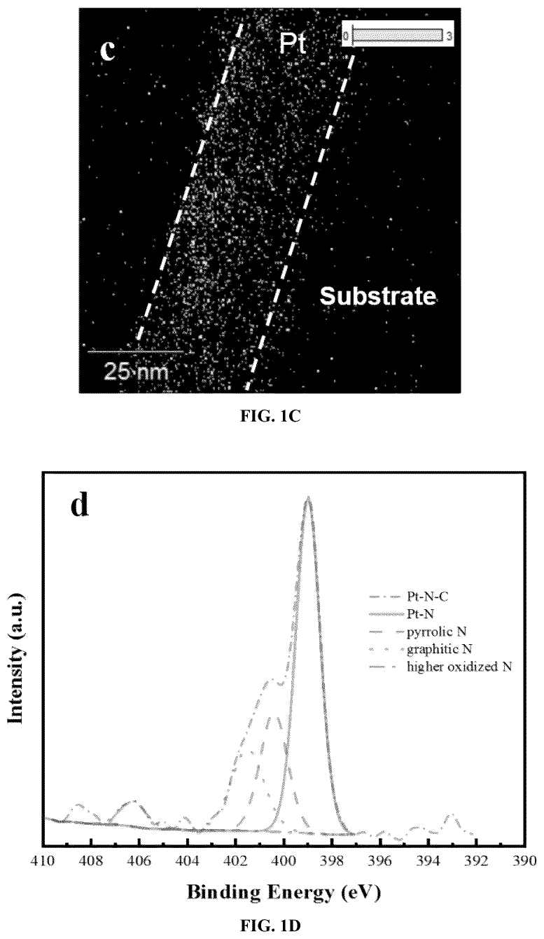

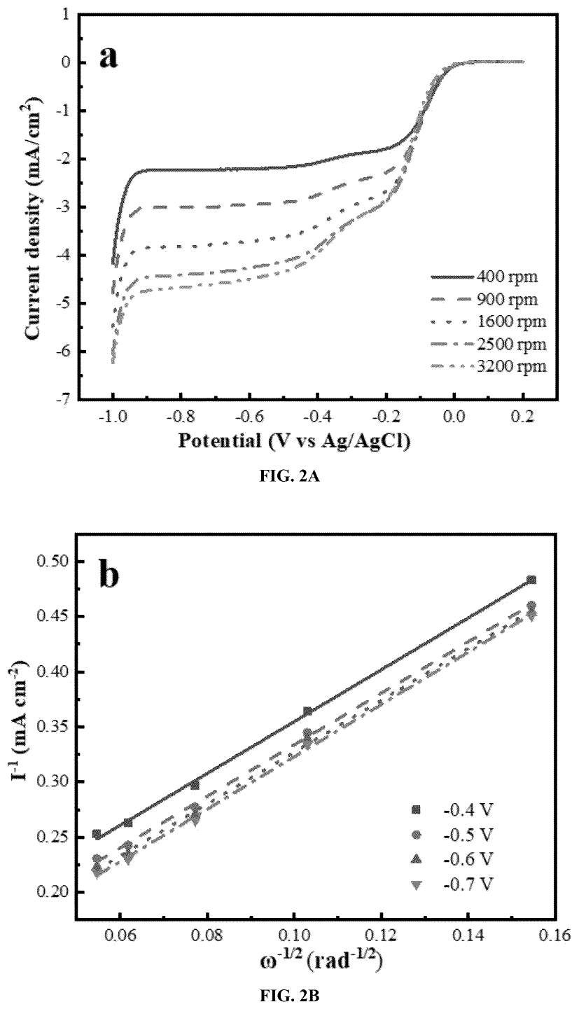

### DETAILED DESCRIPTION OF THE EMBODIMENTS

The following provides further illustration of the present invention, which is not limited thereto.

### Embodiment 1: Preparation Method for Self-Assembly-Based Nitrogen-Doped Ordered Porous Platinum Nanomaterial

The following steps were included.
(1) 20 mg of amphiphilic block copolymer, polystyrene-poly-(4-vinylpyridine) (PS-b-P4VP, of which the number-average molecular weight of polystyrene blocks was 40,500, and the number-average molecular weight of poly-(4-vinylpyridine) blocks was 16,500), and a phenolic resin were dissolved at a mass ratio of 1:1 in 4 mL of N,N-dimethylformamide (DMF) solvent, and then stirred to form an organic solution, with the block copolymer having a concentration of 5 mg/mL.
(2) Chloroplatinic acid was added to allow a molar ratio of Pt to P4VP to reach 1:10, and stirring was continued to form an organic/Pt precursor solution.
(3) The precursor solution prepared in step (2) was transferred to a silicon wafer by means of dip-coating at a withdrawal rate selected to be 5 mm/min, and a Pt/block copolymer/phenolic resin template was formed by self-assembly.
(4) With a nitrogen atmosphere and at 450° C., the template obtained in step (2) was carbonized, and then reduced by introducing an Ar/H₂ reducing gas at the same temperature to obtain a nitrogen-doped ordered mesoporous platinum nanomaterial, where the pores each had an average diameter of about 24 nm, and the Pt nanoparticles had an average diameter of about 2.5 nm.

For a half cell, 5 μl of 0.05% perfluorosulfonic acid-polytetrafluoroethylene Copolymer™ (Nafion™) was dropped onto a rotating disc glassy carbon electrode, and 3 minutes after solvent volatilization, the rotating disc electrode (RDE) was allowed to contact with a carrier loading the nitrogen-doped ordered porous precious metal nanomaterial for 24 hours, to transfer a porous structure to a platinum-carbon electrode.

### Embodiment 2

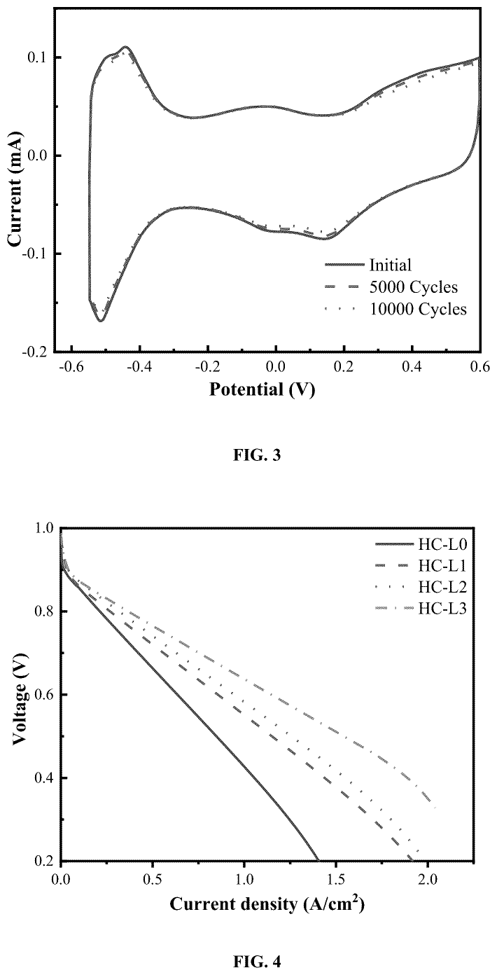

A similar method to Embodiment 1 was used, except step (3) in which a substrate carrier was replaced with ITO glass. The remaining steps were the same, and the resulting CV of the prepared nitrogen-doped ordered porous precious metal nanomaterial was shown in FIG. 3.

### Embodiment 3

A similar method to Embodiment 1 was used, except step (3) in which a substrate carrier was replaced with a piece of carbon paper. Accordingly, the solution was directly spin-coated onto the carbon paper of 2×2 cm², which was then carbonized to obtain samples labelled as HC-L0, HC-L1, HC-L2, and HC-L3, with Pt loads of 0.025 mg/cm², 0.033 mg/cm², 0.068 mg/cm², and 0.102 mg/cm², respectively.

The organic/precious metal precursor solution from step (2) was spin-coated onto the carbon paper of 2×2 cm²; the remaining steps that were the same as those in Embodiment 1 were performed to obtain a carbon paper-supporting nitrogen-doped ordered porous noble metal nanomaterial; and then a membrane electrode (MEA) was assembled for a fuel cell test.

FIG. 4 shows a PEMFC single cell performance test of the nitrogen-doped ordered porous Pt nanomaterial prepared in Embodiment 3. It can be seen that the Pt loading increases with the increase of the layer numbers of the porous structure, and the limit currents of I-V polarization curves increase sequentially, indicating that the cell performances are enhanced in turn.

### Embodiment 4

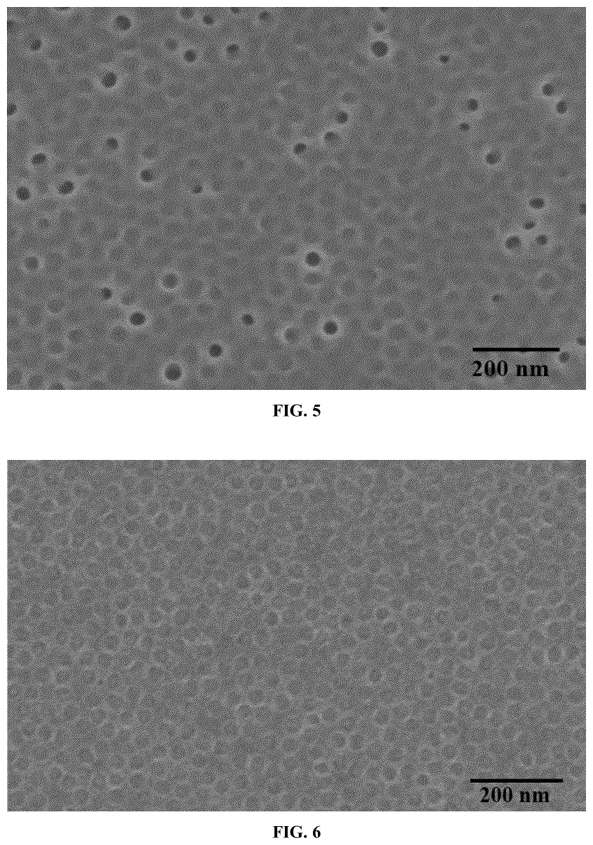

A similar method to Embodiment 1 was used, except that: in step (1), a mass ratio of a block copolymer to a phenolic resin was 1:3; and in step (2), a molar ratio of Pt to P4VP was 1:40. The remaining steps were the same, and the prepared nitrogen-doped ordered porous precious metal nanomaterial was shown in FIG. 5.

### Embodiment 5

A similar method to Embodiment 1 was used, except that: in step (1), a mass ratio of a block copolymer to a phenolic resin was 1:0.5, and the concentration of the block copolymer was 3 mg/mL; and in step (2), a molar ratio of Pt to vinylpyridine was 1:50. The porous structure of the resulting nitrogen-doped ordered porous Pt nanomaterial was shown in FIG. 6.

### Embodiment 6

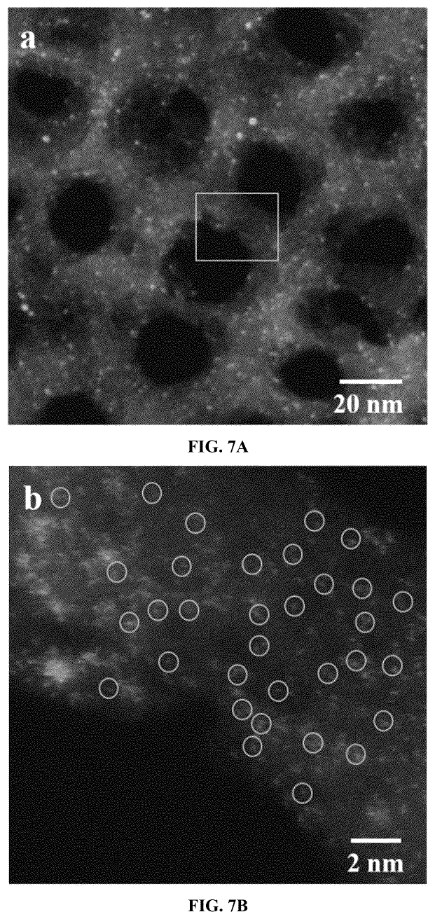

A similar method to Embodiment 1 was used, except step (2) in which a molar ratio of Pt to vinylpyridine was 1:20. The porous structure of the resulting nitrogen-doped ordered porous Pt nanomaterial was shown in FIGS. 7A and 7B. The Pt content was low, and the nanomaterial thus contains Pt single atoms.

### Embodiment 7

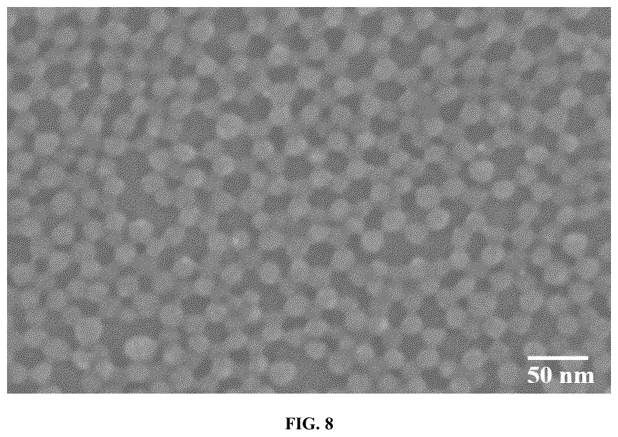

A method similar to Embodiment 1 was used, except that: in the polystyrene-poly-(4-vinylpyridine) in step (1), the number-average molecular weight of polystyrene was 19,900, and the number-average molecular weight of poly-(4-vinylpyridine) was 29,400; and in step (2), a molar ratio of the added Pt to the added vinylpyridine was 1:3; and in step (4), a carbonization temperature was 400° C. The remaining steps were the same. The structure of the resulting nitrogen-doped ordered porous Pt nanomaterial was shown in FIG. 8, in which the diameter of the pore was still about 24 nm, but due to the increase in the use amount of Pt, the pore wall became a bead-like structure, and the diameter of Pt particles was about 25 nm.

### Embodiment 8

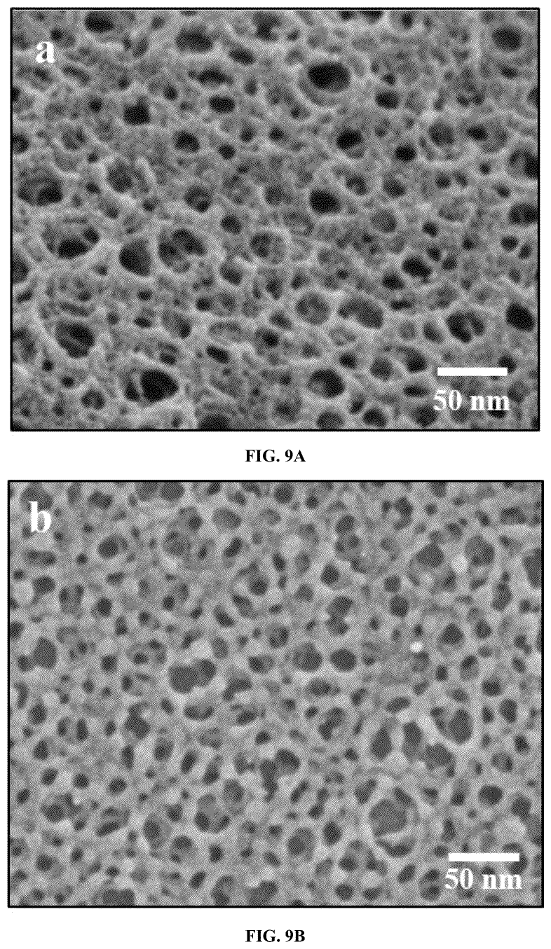

A method similar to Embodiment 7 was used, except step (3) in which the withdrawal rate was changed to 3 mm/min and 1 mm/min; the thickness of the Pt/block copolymer/phenolic resin template increases; and the number of layers of the nitrogen-doped ordered porous Pt nanomaterial increases with the withdrawal rate (FIGS. 9A and 9B).

### Embodiment 9

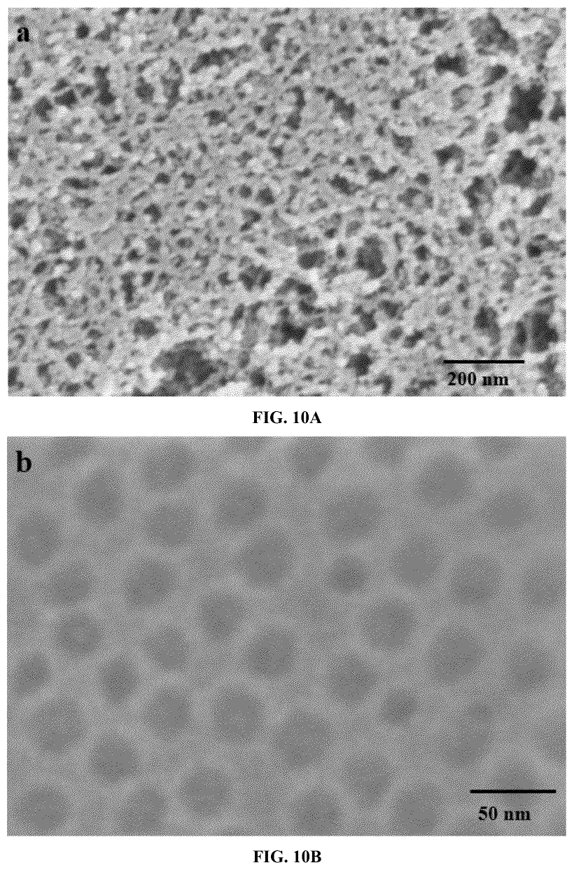

A method similar to Embodiment 1 was used, except that: polystyrene-poly-(2-vinylpyridine) was used in step (1), the number-average molecular weight of polystyrene was 40,000, the number-average molecular weight of poly-(2-vinylpyridine) was 18,000, and the concentration of the block copolymer was 10 mg/mL; and in step (3), the solution was transferred to a silicon wafer by a spin-coating method, at spin-coating rates of 400 rpm and 3,000 rpm, respectively. The remaining steps were the same. The porous structure of the resulting nitrogen-doped ordered porous Pt nanomaterial was shown in FIGS. 10A and 10B, with 400 rpm in FIG. 10A and 3,000 rpm in FIG. 10B.

### Embodiment 10

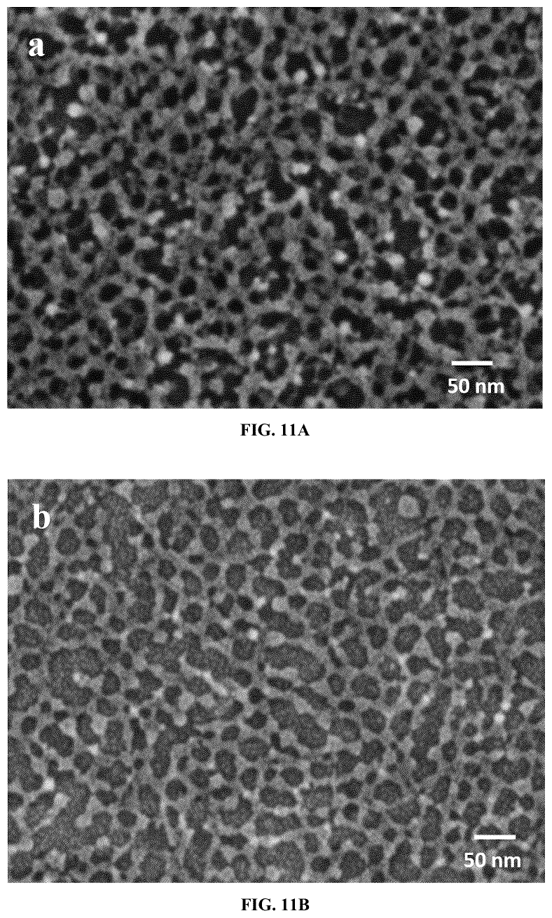

A method similar to Embodiment 1 was used, except that: in step (2), the added precious metal precursor was Au, and a molar ratio of Au to vinylpyridine was 1:5; and in step (3), the withdrawal rates were 5 mm/min and 3 mm/min, respectively. The porous structure of the resulting nitrogen-doped ordered porous Au nanomaterial was shown in FIGS. 11A and 11B.

### Embodiment 11

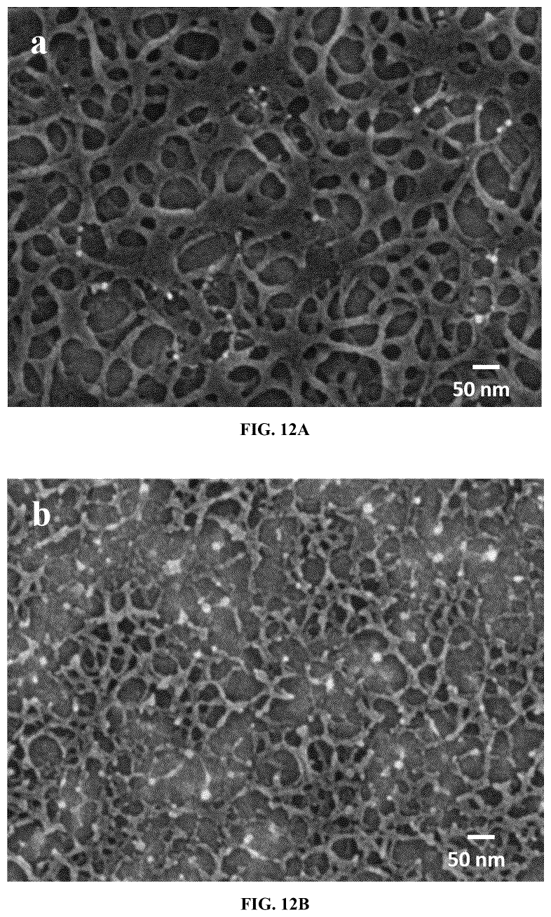

A method similar to Embodiment 10 was used, except that: in step (1), a mass ratio of polystyrene-poly-(4-vinylpyridine) to phenolic resin was 1:2; in step (2), the added precious metal precursor was Ir, and a molar ratio of Ir to vinylpyridine was 1:20; and in step (4), the carbonization temperature was 500° C. The porous structure of the resulting nitrogen-doped ordered porous Ir nanomaterial was shown in FIGS. 12A and 12B.

### Embodiment 12

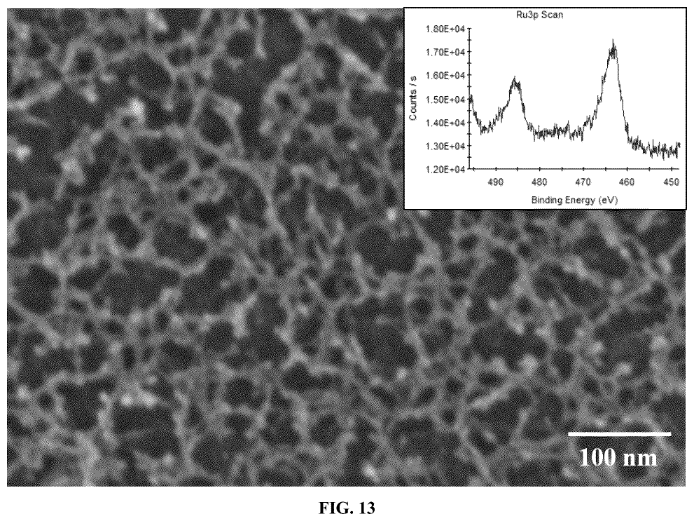

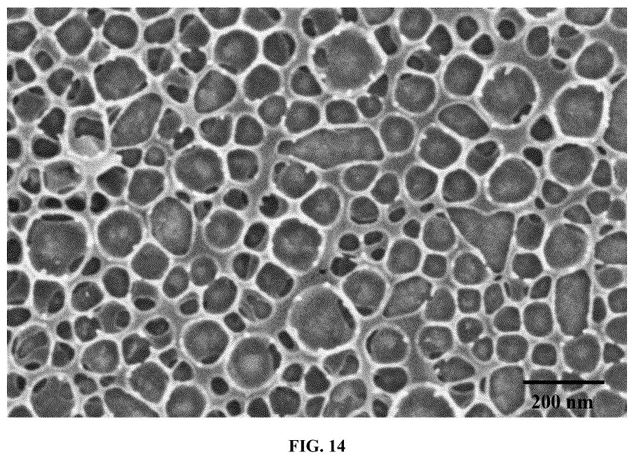

A method similar to Embodiment 10 was used, except that: in step (2), the added precious metal precursor was Ru, and a molar ratio of Ru to vinylpyridine was 1:10; and in step (3), a template was prepared by a spin-coating method at a spin-coating rate of 1,500 r/min. The porous structure of the resulting nitrogen-doped ordered porous Ru nanomaterial was shown in FIG. 13.

### Embodiment 13

A method similar to Embodiment 1 was used, except that: in the polystyrene-poly-(4-vinylpyridine) used in step (1), the number-average molecular weight of polystyrene was 41,500, the number-average molecular weight of poly-(4-vinylpyridine) was 17,500, and a mass ratio of the block copolymer to the phenolic resin in step (1) was 1:0.5; and in step (3), the precious metal precursor included Pt and Ru, and a molar ratio of the total atomic weight of Pt and Ru to vinylpyridine was 1:50; The porous structure of the resulting nitrogen-doped ordered porous precious metal nanomaterial was shown in FIG. 14.

What is claimed is:

1. A preparation method for a self-assembly-based nitrogen-doped ordered porous precious metal nanomaterial, comprising: with a pyridine nitrogen-containing amphiphilic block copolymer as a structure-directing agent and a phenolic resin as a template agent, adding a precious metal precursor, inducing self-assembly by volatilization of a solvent, and carbonizing in an inert atmosphere to prepare the nitrogen-doped ordered porous precious metal nanomaterial, wherein the nitrogen-doped ordered porous precious metal nanomaterial has a honeycomb- or mesh-like porous structure having pore channels orderly arranged and precious metal particles uniformly located on surfaces or pore walls of the nitrogen-doped ordered porous precious metal nanomaterial.

2. The preparation method for the self-assembly-based nitrogen-doped ordered porous precious metal nanomaterial according to claim 1, wherein the preparation method comprises the following steps:
(1) dissolving the amphiphilic block copolymer and the phenolic resin at a weight ratio of 1:(0.5-3) in N,N-dimethylformamide, and stirring to form a clear organic solution, the amphiphilic block copolymer having a concentration of 3-10 mg/mL;
(2) adding the precious metal precursor to the clear organic solution obtained in step (1), and continuing to stir to form an organic/precious metal precursor solution, a molar ratio of a precious metal in the precious metal precursor to a hydrophilic block unit in the amphiphilic block copolymer being 1:(1-50);
(3) transferring the organic/precious metal precursor solution obtained in step (2) to a carrier, and performing self-assembly at room temperature to form an organic/precious metal template; and
(4) carbonizing the organic/precious metal template obtained in step (3) at a temperature between 400° C. and 500° C. in an inert atmosphere, and then performing reduction by introducing a reducing gas at the same temperature to obtain the nitrogen-doped ordered porous precious metal nanomaterial.

3. The preparation method for the self-assembly-based nitrogen-doped ordered porous precious metal nanomaterial according to claim 1, wherein in the amphiphilic block copolymer, a hydrophilic block is selected from poly-(4-vinylpyridine) or poly-(2-vinylpyridine), and a hydrophobic block is polystyrene.

4. The preparation method for the self-assembly-based nitrogen-doped ordered porous precious metal nanomaterial according to claim 1, wherein the precious metal in the precious metal precursor comprises at least one selected from the group consisting of platinum, gold, iridium, and ruthenium.

5. The preparation method for the self-assembly-based nitrogen-doped ordered porous precious metal nanomaterial according to claim 1, wherein the orderly arranged pores of the nitrogen-doped ordered porous precious metal nanomaterial each have an average diameter in a range of 10 nm to 200 nm; and the precious metal particles each have an average diameter in a range of 0.2 nm to 25 nm.

6. The preparation method for the self-assembly-based nitrogen-doped ordered porous precious metal nanomaterial according to claim 1, wherein the carrier in step (3) comprises carbon paper, ITO glass, or a silicon wafer.

7. A use method of the nitrogen-doped ordered porous precious metal nanomaterial prepared according to the preparation method of claim 1, comprising: using the nitrogen-doped ordered porous precious metal nanomaterial for catalysis in a cathode of a fuel cell.

8. The use method according to claim 7, wherein the nitrogen-doped ordered porous precious metal nanomaterial is used in preparation of a cathodic oxygen reduction catalyst for the fuel cell.

9. The preparation method for the self-assembly-based nitrogen-doped ordered porous precious metal nanomaterial according to claim 2, wherein in the amphiphilic block copolymer, a hydrophilic block is selected from poly-(4-vinylpyridine) or poly-(2-vinylpyridine), and a hydrophobic block is polystyrene.

10. The preparation method for the self-assembly-based nitrogen-doped ordered porous precious metal nanomaterial according to claim 2, wherein the precious metal in the precious metal precursor comprises at least one selected from the group consisting of platinum, gold, iridium, and ruthenium.

11. The preparation method for the self-assembly-based nitrogen-doped ordered porous precious metal nanomaterial according to claim 2, wherein the orderly arranged pores of the nitrogen-doped ordered porous precious metal nanomaterial each have an average diameter in a range of 10 nm to 200 nm; and the precious metal particles each have an average diameter in a range of 0.2 nm to 25 nm.

12. The preparation method for the self-assembly-based nitrogen-doped ordered porous precious metal nanomaterial according to claim 2, wherein the carrier in step (3) comprises carbon paper, ITO glass, or a silicon wafer.

13. The use method according to claim 7, wherein the preparation method comprises the following steps:
(1) dissolving the amphiphilic block copolymer and the phenolic resin at a weight ratio of 1:(0.5-3) in N,N-dimethylformamide, and stirring to form a clear organic solution, the amphiphilic block copolymer having a concentration of 3-10 mg/mL;
(2) adding the precious metal precursor to the clear organic solution obtained in step (1), and continuing to stir to form an organic/precious metal precursor solution, a molar ratio of a precious metal in the precious metal precursor to a hydrophilic block unit in the amphiphilic block copolymer being 1:(1-50);
(3) transferring the organic/precious metal precursor solution obtained in step (2) to a carrier, and performing self-assembly at room temperature to form an organic/precious metal template; and
(4) carbonizing the organic/precious metal template obtained in step (3) at a temperature between 400° C. and 500° C. in an inert atmosphere, and then performing reduction by introducing a reducing gas at the same temperature to obtain the nitrogen-doped ordered porous precious metal nanomaterial.

14. The use method according to claim 7, wherein in the preparation method, in the amphiphilic block copolymer, a hydrophilic block is selected from poly-(4-vinylpyridine) or poly-(2-vinylpyridine), and a hydrophobic block is polystyrene.

15. The use method according to claim 7, wherein in the preparation method, the precious metal in the precious metal precursor comprises at least one selected from the group consisting of platinum, gold, iridium, and ruthenium.

16. The use method according to claim 7, wherein in the preparation method, the orderly arranged pores of the nitrogen-doped ordered porous precious metal nanomaterial each have an average diameter in a range of 10 nm to 200 nm; and the precious metal particles each have an average diameter in a range of 0.2 nm to 25 nm.

17. The use method according to claim 7, wherein in the preparation method, the carrier in step (3) comprises carbon paper, ITO glass, or a silicon wafer.
